(19) United States
(12) Patent Application Publication
(10) Pub. No.: US 2015/0006824 A1
(43) Pub. Date: Jan. 1, 2015

(54) APPARATUS AND METHOD OF DETECTING PERIODICITY OF MEMORY

(71) Applicant: Samsung Electronics Co., Ltd, Suwon-si (KR)

(72) Inventors: Myung-June JUNE, Suwon-si (KR); Ju-Pyung LEE, Suwon-si (KR)

(73) Assignee: Samsung Electronics Co., Ltd, Suwon-si (KR)

(21) Appl. No.: 14/317,209

(22) Filed: Jun. 27, 2014

(30) Foreign Application Priority Data
Jun. 28, 2013 (KR) 10-2013-0075918

(51) Int. Cl. G06F 12/12

(52) U.S. Cl. CPC G06F 12/122
USPC 711/136

(57) ABSTRACT

An apparatus to detect access periodicity of memory to manage cache pages includes a periodicity value calculator to calculate periodicity of a first period with respect to addresses in memory, and a periodicity determiner to determine periodicity of a first period based on the first periodicity value of the first period which is calculated with respect to the address at a point in time when a second period has elapsed.

### CROSS-REFERENCE TO RELATED APPLICATIONS

This application claims priority under 35 U.S.C. §119(a) of Korean Patent Application No. 10-2013-0075918 filed on Jun. 28, 2013 in the Korean Intellectual Property Office, the disclosure of which is incorporated herein by reference it its entirety.

### BACKGROUND

1. Field

The present general inventive concept relates to an apparatus and method of detecting periodicity of memory, and more specifically to an apparatus and method capable of being applied to cache management of a cache system.

2. Description of the Related Art

Generally, a Least Recently Used (LRU) algorithm and a Least Frequently Used (LFU) algorithm, etc. are used to distinguish between data to keep or discard in a page cache or a block cache system. However, although these algorithms have advantages of easily distinguishing recency characteristic corresponding to each page stored in the cache, these algorithms have difficulty recognizing other meaningful characteristics, such as periodicity. To solve this, variations of the LRU and LFU algorithms have been introduced. However, they are inefficient in terms of computation overhead and memory space consumption, so the various algorithms are not used often.

### SUMMARY

The present general concept provides an apparatus to detect periodicity of a memory using a periodicity determiner.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing an apparatus to detect periodicity of a memory including a periodicity value calculator to calculate a periodicity value of a first period with respect to an address in the memory, and a periodicity determiner to determine periodicity of the first period on a basis of the periodicity value of the first period, which is calculated with respect to the address at a point in time when a second period has elapsed.

The periodicity value calculator may calculate the periodicity value of the first period with respect to the address based on a number of accesses to the address, which is calculated corresponding to each interval of the first period during the second period.

If the number of accesses to the address corresponding to each interval of the first period is equal to or greater than 1, the periodicity value calculator may increase the periodicity value by a predetermined value, and if the number of accesses to the address corresponding to each interval of the first period is 0, the periodicity value calculator may maintain or decrease the periodicity value by a predetermined value.

If the periodicity value of the first period, which is calculated with respect to the address, is greater than a predetermined reference value, the periodicity determiner may determine that the address has the periodicity of the first period.

The foregoing and/or other features and utilities of the present general inventive concept may also be achieved by providing a method of detecting periodicity of a memory may include calculating a periodicity value of a first period with respect to an address in the memory, and determining periodicity of the first period based on the periodicity value of the first period which is calculated with respect to the address at a point in time when a second period has elapsed.

The calculating of the periodicity value of the first period may include counting a number of accesses to the address corresponding to each interval of the first period during the second period, and calculating the periodicity value of the first period with respect to the address based on the calculated number of accesses.

The calculating of the periodicity value may include, if the number of accesses to the address corresponding to each interval of the first period is equal to or greater than 1, increasing the periodicity value by a predetermined value, and if the number of accesses to the address corresponding to each interval of the first period is 0, maintaining or decreasing the periodicity value by a predetermined value.

The determining of the periodicity of the first period may include comparing the periodicity value of the first period with a predetermined reference value; and in response to a comparison result indicating that the periodicity value of the first period is greater than a predetermined reference value, determining that the address has periodicity of the first period.

The foregoing and/or other features and utilities of the present general inventive concept may also be achieved by providing an apparatus to detect periodicity of a memory, including a periodicity value calculator to count a number of times a memory address of the memory is accessed to detect a periodicity value of a first period of time with respect to the memory address, and a periodicity determiner to determine periodicity of the first period based on the periodicity value of the first period.

The periodicity value calculator may count the number of times the memory address is accessed according to a data input/output (I/O) of the memory address.

The periodicity value may be calculated with respect to the address at a point in time when a second period has elapsed.

The determining of the periodicity of the first period may include comparing the periodicity value of the first period with a predetermined reference value to determine the periodicity of the first period based on the comparison result.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 is a diagram illustrating an example of an apparatus to detect periodicity of a memory, according to an exemplary embodiment of the present general inventive concept.

FIGS. 2A through 2F are diagrams illustrating examples of processes of detecting periodicity of a memory, according to an exemplary embodiment of the present general inventive concept.

FIG. 3 is a flowchart illustrating an example of a method of detecting periodicity of a memory, according to an exemplary embodiment of the present general inventive concept.

FIG. 4 is a flowchart specifically illustrating an example of a method of detecting periodicity of a memory, according to an exemplary embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

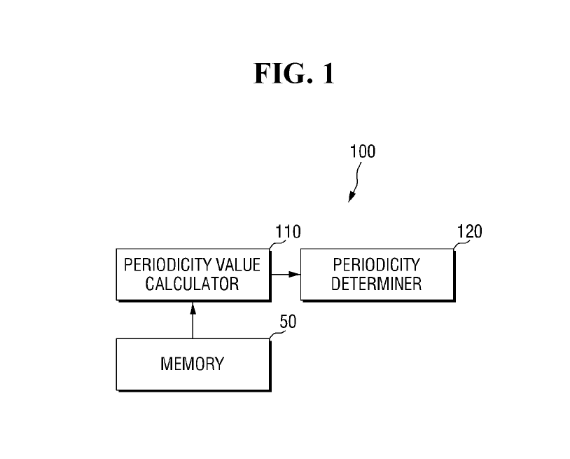

FIG. 1 is a diagram illustrating an example of an apparatus 100 to detect periodicity of a memory 50, according to an exemplary embodiment of the present general inventive concept.

In an exemplary embodiment of the present general inventive concept the apparatus 100 to detect periodicity of the memory 50, as illustrated in FIG. 1, may be applied to a memory cache system. That is, the apparatus 100 to detect periodicity may be used as a means of determining which page to save or discard from cache in a system, such as a general RAM-based main memory unit where the cache is allocated. In another exemplary embodiment of the present general inventive concept, in a hybrid cache system that includes both a high speed RAM-based main memory unit with relatively small capacity and a low speed secondary memory unit (for example, SSD) with relatively large capacity where cache is allocated, the apparatus 100 may be used to determine which page to save in the cache allocated to the main memory unit, or which page to save in and discard from each cache allocated in the secondary memory unit.

In an exemplary embodiment of the present general inventive concept, the apparatus 100 may be used to detect periodicity of each page stored in a cache. The periodicity characteristics, which have been detected from each page, may be replaced with or used together with characteristics obtained by general algorithms Least Recently Used (LRU) or Least Frequently Used (LFU). By those operations, even though a page is likely to be discarded from the cache because of a lack of recency, if any periodicity is detected, the page can be continuously saved in the cache as it is, or transferred and stored in a relatively large cache, so that a cache hit ratio can increase by lessening computation overhead or memory space consumption.

Referring to FIG. 1, the apparatus 100 includes a periodicity value calculator 110 and a periodicity determiner 120.

The periodicity value calculator 110 calculates a periodicity value of a first period of time (hereinafter referred to as ‘a first period’ or ‘the first period’) according to a memory address. Here, the memory may refer to a cache area that allocated in the memory 50. Also, the memory address may refer to an address corresponding to each page that is stored in each cache area. However, the periodicity value calculator 110 is not limited to those exemplary embodiments described above. So, the memory 50 and the memory address therewithin may be broadly interpreted to include all types of storage units, such as RAM, HDD, and SSD, in which data is stored, and addresses of such storage units where data is stored.

In an exemplary embodiment of the present general inventive concept, the periodicity value calculator 110 may first count a number of times the address is accessed according to a data I/O request of the memory address to detect the periodicity value of the first period. Also, the number of times the address is accessed may be counted during every interval of the first period during a second period of time (hereinafter referred to as ‘a second period’ or ‘the second period’). Here, the first period refers to a time unit to determine a periodicity of the address, and the second period refers to a time unit to determine whether the first period has periodicity. In addition, the interval of the first period refers to the interval separated by the first period's time unit during the second period's time unit.

Moreover, the periodicity value calculator 110 may calculate the periodicity value of the first period with respect to the address on the basis of the number of accesses to the address, which is calculated at each interval of the first period during the second period. For example, the periodicity value calculator 110 may increase the periodicity value of the first period by a predetermined value (i.e., 1) if the number of the accesses to the address calculated at each interval of the first period with respect to that address is greater than or equal to 1. If the number of the accesses is 0, the periodicity value calculator 110 may maintain the periodicity value or decrease the periodicity value by a predetermined value, and then detect a final periodicity value.

A periodicity determiner 120 determines the first period periodicity based on the periodicity value of the first period that has been calculated with respect to an address of the memory 50 at a point in time at which the second period elapses. Here, determining the periodicity of the first period may refer to a determination of whether a periodic characteristic of data I/O requests to the address data occurs by a first period unit exists in that address. Likewise, the periodicity determiner 120 may compare the periodicity value of the first period with a predetermined reference value to determine the periodicity of the first period based on the comparison result. For instance, as a result of the comparison, if the periodicity value of the first period is greater than or equal to the predetermined reference value, it may be determined that the address has the periodicity of the first period. In other words, the I/O request to the address may decide that the periodic characteristic that occurs by the first period unit exists.

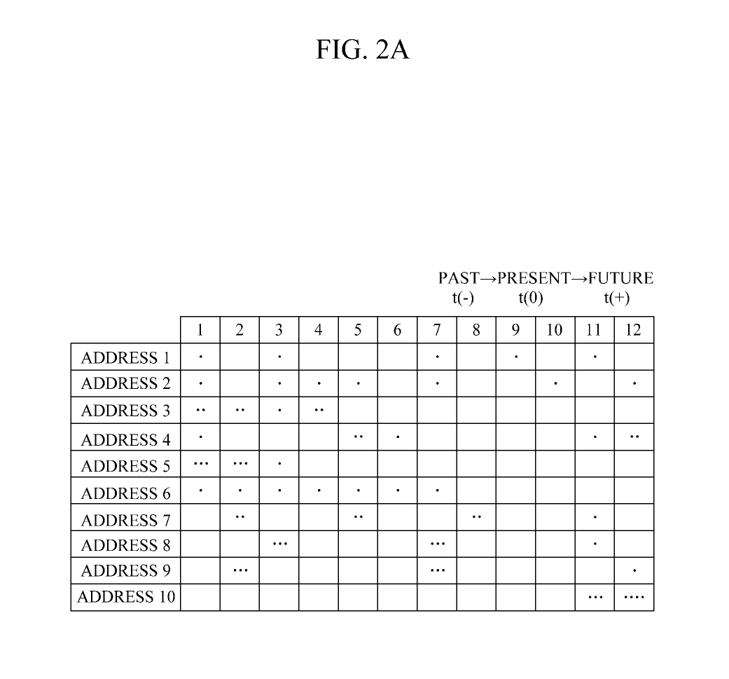

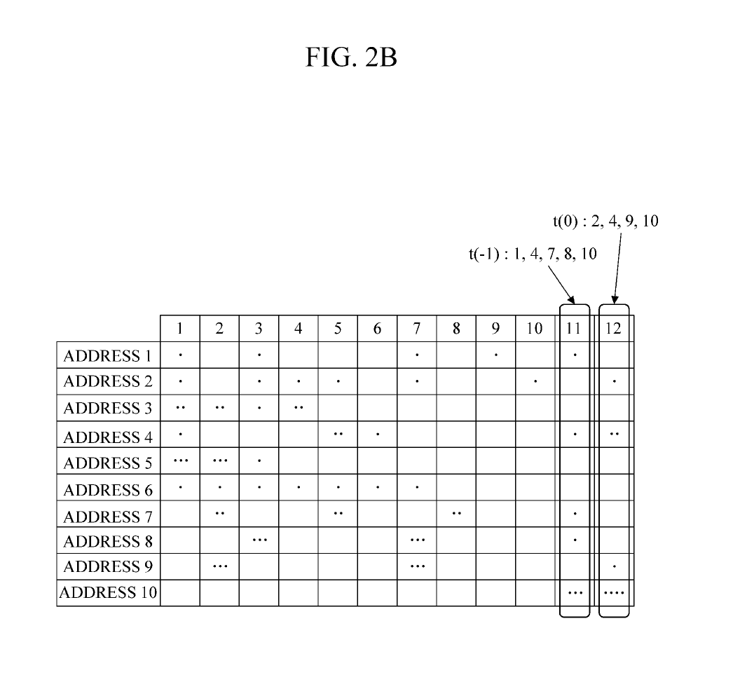

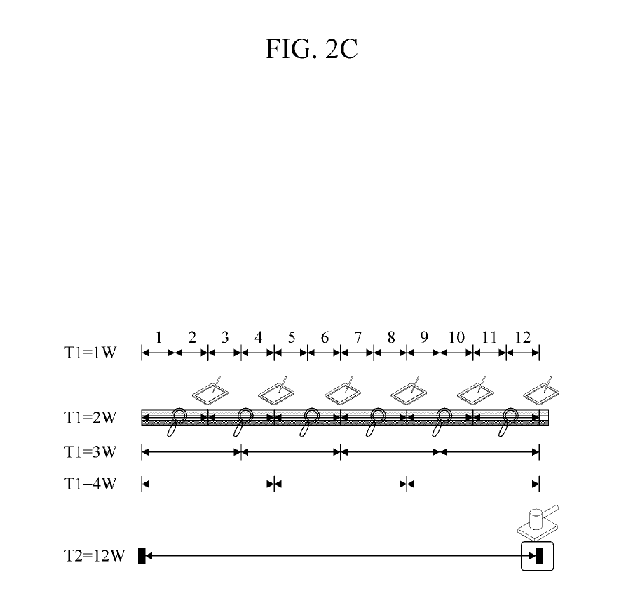

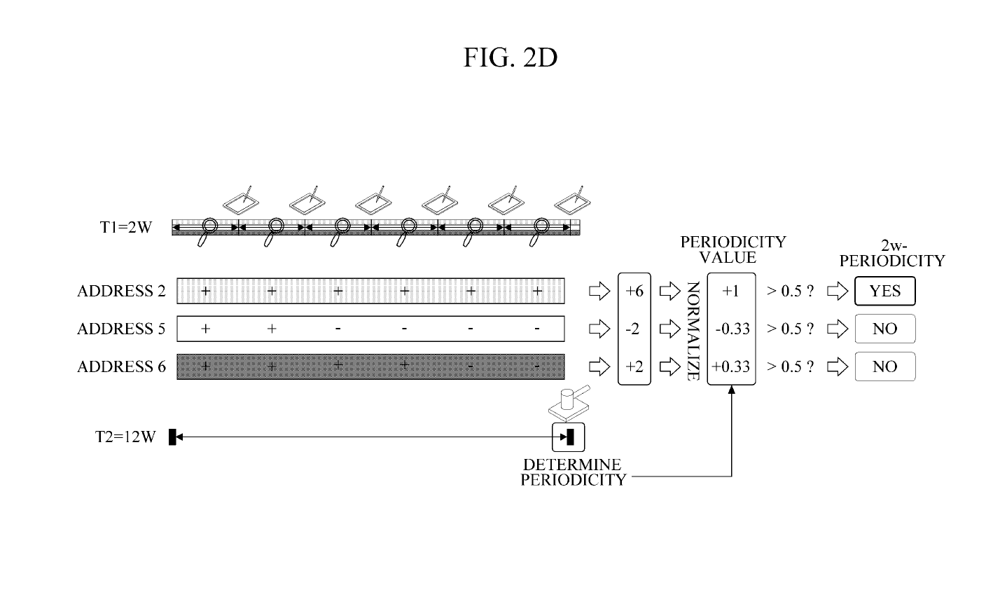

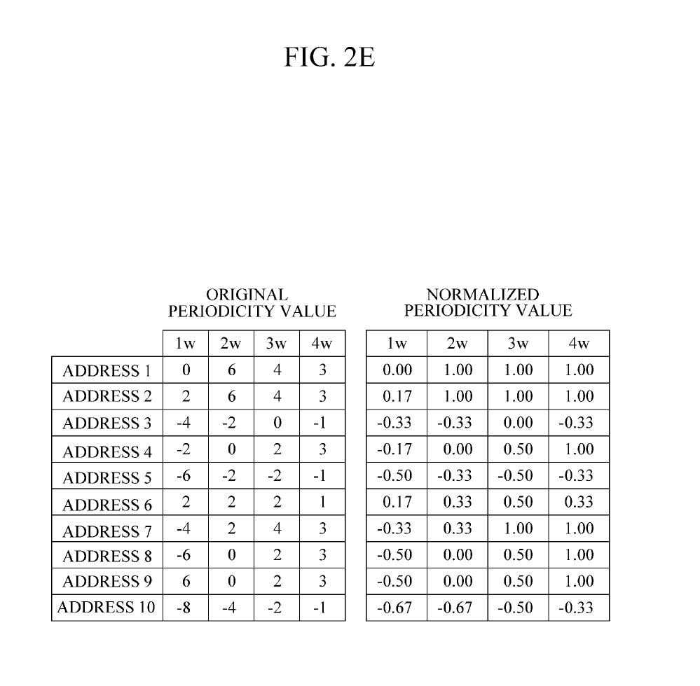

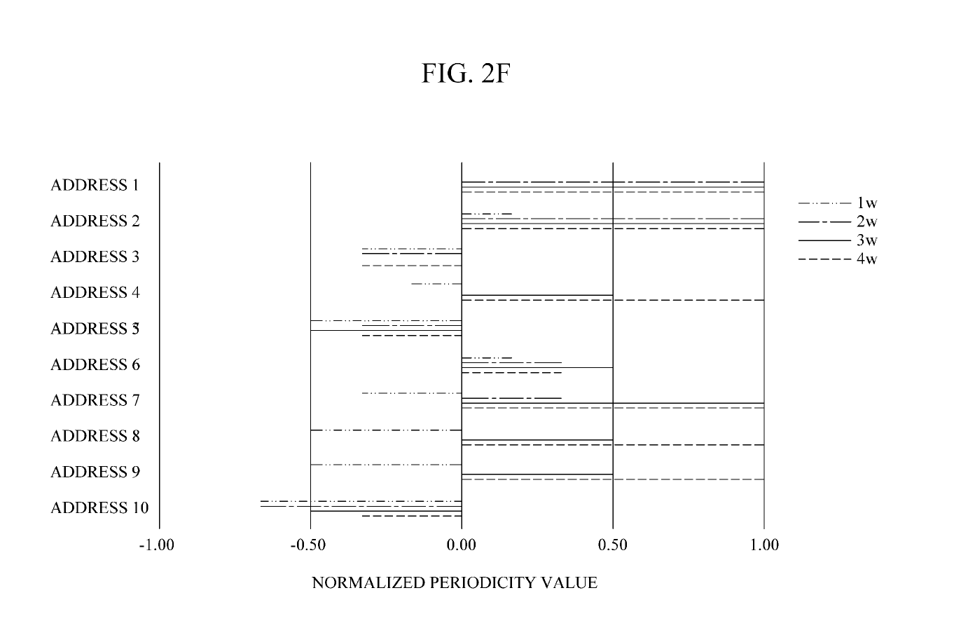

FIGS. 2A through 2F are diagrams illustrating examples of processes of detecting periodicity of a memory.

Referring FIGS. 1 through 2F, processes of detecting periodicity of a memory 50 through an apparatus 100 to detect periodicity of the memory 50 are described hereafter.

FIG. 2A is a table illustrating a final result of a number of times each address of the memory 50 is accessed during an overall 12 unit time period. More specifically, a dot represents a single memory access in a given time period unit. Therefore, for example, at a unit 4 time period, addresses 2 and 6 are accessed once, while address 3 is accessed twice.

FIG. 2B illustrates a result derived from determining which address is to be saved in a cache by using a general LRU algorithm based on the final result of FIG. 2A. The LRU algorithm is used to determine recently used data as data that is to be saved in the cache. Based on the LRU algorithm, at a current point in time t(0), addresses 2, 4, 9, and 10, each of which has been accessed at least once, are determined to be saved, and addresses 1, 3, 5, 6, 7, and 8 are determined to be discarded. Meanwhile, at a past point in time t(−1), addresses 1, 4, 7, 8, and 10 are determined to be saved, and addresses 2, 3, 5, 6, and 9 are determined to be discarded.

Although the LRU algorithm can detect recency characteristics without complicated calculations, if detected windows were increased, it might be difficult for the LRU algorithm to accurately distinguish between data corresponding to an I/O request that is relatively frequently generated, and data corresponding to an I/O request that is not frequently generated. For example, according to an illustrative example of FIG. 2B, the addresses 1, 7, and 8 may be considered somewhat periodic. However, because no I/O request occurs at addresses 1, 7, and 8 at the current point in time t(0), the addresses 1, 7, and 8 are determined to be discarded. As a result, problems arise when an I/O request occurs at a subsequent point in time, and data of the addresses 1, 7, and 8 cannot be serviced quickly.

FIG. 2C is a diagram illustrating an example of first and second periods T1 and T2, respectively, which are set to determine periodicity corresponding to each address by using a final result derived from the number of times each address of FIG. 2A is accessed.

Referring to FIG. 2C, the first period T1 to determine periodicity may be set to include more than one 1W, 2W, 3W, and 4W within a range of a second period T2. Also, as illustrated in FIG. 2C, the second period T2, which represents a point in time at which the periodicity of the first period T1 is determined, is set to have 12W. Here, “W” represents a “window,” which is a time period during which observation occurs, and one window refers to one time unit illustrated in FIG. 2A. Accordingly, if the first period T1 is 1W, all 12 intervals, each including 1W, exist during the second period T2. And if the first period T1 is 2W, 6 intervals, each including 2W, exist during the second period T2.

FIG. 2D is a diagram illustrating an example of processes of determining periodicity of a first period T1, which is set as 2W illustrated in FIG. 2C, with respect to addresses 2, 5, and 6 illustrated in FIG. 2A. Here, the second period T2 is 12W, so 12 time units illustrated in FIG. 2A are included the second period. Also, the first period T1 includes 6 intervals overall, each of which includes two successive time units during 12W. Hereinafter, for description convenience, the time units 1 and 2 are referred to as a 1st interval; the time units 3 and 4, a 2nd interval; the time units 5 and 6, a 3rd interval; the time units 7 and 8, a 4th interval; the time units 9 and 10, a 5th interval; the time units 11 and 12, a 6th interval.

As illustrated in FIG. 2D, a periodicity value decreases by 1 if a number of accesses to the address is 0, but is not limited to above-mentioned description. For example, in contrast to the example in FIG. 2D, if the number of the accesses is 0, the periodicity value may not be modified and maintained.

With respect to addresses 2, 5, and 6 illustrated in FIG. 2A, the periodicity value calculator 110 may increase the periodicity value by 1 if the number of the accesses counted within every interval of the first period T1 is greater than or equal to 1 during the second period T2, which includes 12W. Also, if the number of the accesses to the address is 0, the periodicity value calculator 110 may decrease the periodicity value by 1. As a result, the periodicity value of the address 2 is 6 because it is accessed at least more than once in all intervals. In addition, in the case of the address 5 with number of times accessed only in the 1^{st} interval and 2^{nd} interval, a total increased value is 2 and a total decreased value is 4, so the periodicity value comes to −2. The address 6 has the number of the accesses from the 1^{st} interval to the 4^{th} interval, but not in the 5^{th} interval and the 6^{th} interval. As a result, the periodicity value of the address 6 is 2.

Here, the calculated periodicity value may go through a predetermined normalizing process. For example, the periodicity value may be normalized to have a minimum value of −1 to a maximum value of 1. Referring to FIG. 2D, the calculated periodicity value may be normalized to have a value of −1 through 1 after being divided by 6. As a result, after normalization, each final periodicity value of the addresses 2, 5, and 6 becomes 1, −0.33, and 0.33, respectively. Likewise, through a normalization process, it becomes easier to determine that the periodicity increases as the periodicity value approaches the maximum value of 1.

The periodicity determiner 120 may compare a periodicity value with a reference value 0.5 that is set in advance, wherein the periodicity value has been normalized at a point in time when the second period T2 of 12W has elapsed. As a result of the comparison, the address 2 with the periodicity value that exceeds the reference value may be determined as having the periodicity of 2W. However, addresses 5 and 6 do not exceed the reference value, and, thus, are determined as not having the periodicity of 2W.

However, the normalizing process of the calculated periodicity value is not a necessary process, and the periodicity period may be directly used without normalization.

FIG. 2E is a diagram illustrating a result derived from calculating each periodicity value with respect to each address 1 through 10 corresponding to each 1W, 2W, 3W, and 4W of a first period T1, which has been set as illustrated in FIGS. 2C and 2D. FIG. 2F is a diagram illustrating a result derived from calculating a periodicity value as illustrated in FIG. 2E. Referring to FIG. 2F, a first period that has periodicity corresponding to each address 1 through 10 may be easily distinguished. Where a reference value has been set as 0.5, addresses 1 and 2 are considered to have the periodicities of 2W, 3W and 4W, and addresses 4, 8, and 9 are considered to have the periodicity of 4W. In addition, it may be easily determined that addresses 3, 5, and 10 do not have periodicity corresponding to any of 1W, 2W, 3W, and 4W of the first period T1 that has been set.

Likewise, in another embodiment of the present general inventive concept, since an apparatus to detect periodicity of a memory may detect the periodicity through an arithmetic operation of counting a number of accesses, computation overhead is very small. Also, consuming memory space only as much as it can maintain the number of the accesses, the apparatus is greatly efficient in terms of space.

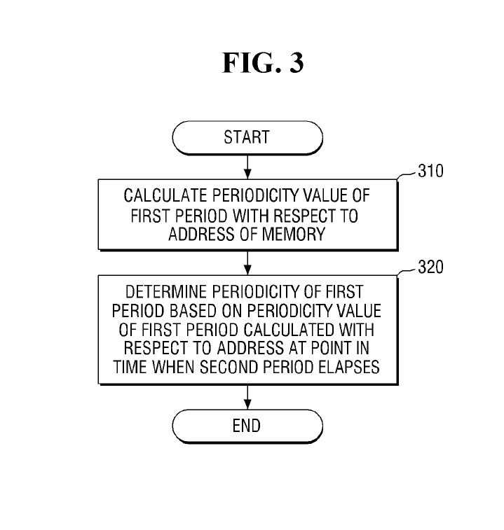

FIG. 3 is a flowchart illustrating an example of a method of detecting periodicity of a memory.

The flowchart illustrated in FIG. 3 may be implemented by the apparatus 100 of FIG. 1 of detecting periodicity of a memory 50. Since the example of the method of detecting periodicity of the memory 50, which is implemented by the apparatus 100, has been described above in detail referring to FIGS. 1 through 2F, the method will be described simply to avoid repetition.

First, a periodicity value of a first period may be calculated in operation 310. The apparatus 100 to detect periodicity may count the number of times the address is accessed in response to a data I/O request with respect to one predetermined address of the memory 50, and then based on the number of the accesses to the address, the periodicity value of the first period corresponding to the address may be calculated. For example, the number of the accesses may be calculated corresponding to each interval of the first period during a second period. As a result, if the number of the accesses calculated corresponding to each interval is more than or equal to 1, the periodicity value may be increased by a predetermined value. Also, if the number of the accesses is 0, the periodicity value may be either maintained or decreased by a predetermined value. Through these operations, the periodicity value may be calculated.

Next, based on the periodicity value of the first period, which is calculated with respect to the address at the point in time when the second period has elapsed, the periodicity of the first period may be determined in operation 320. For example, after comparing a periodicity value of the calculated first period with a predetermined reference value, if the periodicity value of the first period exceeds the predetermined reference value, it may be determined that the address has the periodicity of the first period.

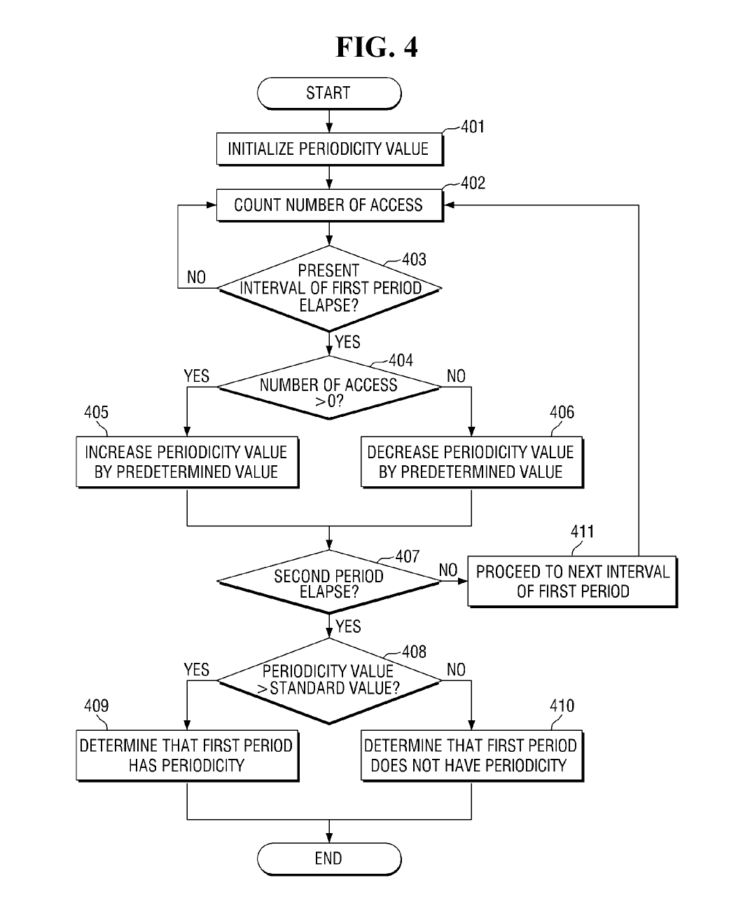

FIG. 4 is a detailed flowchart illustrating an example of a method of detecting periodicity of a memory 50. Referring to FIG. 4, the method of detecting periodicity may be described more in detail hereafter.

At first, when a second period starts, a periodicity value of the address is initialized to a preset value, such as 0 in operation 401. Then, the number of the accesses to the address may be calculated in a current interval of a first period that has been set in operation 402. Next, the current interval of the first period may be checked in operation 403, and if the current interval has not elapsed, the number of the accesses in the current interval may be calculated continuously in operation 402.

Where the current interval has elapsed, it may be determined whether the number of the accesses to the address is greater than 0. In other words, it may be determined whether the number of the accesses to the address is accessed is greater than or equal to 1 in operation 404. If the number of accesses is greater than or equal to 1, the periodicity value may be increased by a predetermined value in operation 405; otherwise, the periodicity value may be either maintained or decreased by a predetermined value in operation 406.

Next, whether the second period has elapsed may be checked in operation 407. If the second period has not yet elapsed, the apparatus 100 proceeds to a next interval of the first period in operation 411, and then counts the number of accesses to the address in operation 402. If the second period has already elapsed, the calculated periodicity value is compared with a reference (i.e., a standard) value in operation 408. After operation 408, if the periodicity value is greater than the reference value, it is determined that the first period has the periodicity corresponding to the address in operation 409. Otherwise, it is determined that the first period does not have the periodicity corresponding to the address in operation 410.

The cache can be managed very efficiently in terms of computation overhead and memory space by using the detected periodicity characteristics from detecting the periodicity of each address based on the number of times the memory 50 accessed.

The methods and/or operations described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An apparatus to detect periodicity of memory, comprising:
a periodicity value calculator to calculate a periodicity value of a first period with respect to an address in the memory; and
a periodicity determiner to determine periodicity of the first period on a basis of the periodicity value of the first period, which is calculated with respect to the address at a point in time when a second period has elapsed.

2. The apparatus of claim 1, wherein the periodicity value calculator calculates the periodicity value of the first period with respect to the address based on a number of accesses to the address, which is calculated corresponding to each interval of the first period during the second period.

3. The apparatus of claim 2, wherein if the number of accesses to the address corresponding to each interval of the first period is equal to or greater than 1, the periodicity value calculator increases the periodicity value by a predetermined value, and if the number of accesses to the address corresponding to each interval of the first period is 0, the periodicity value calculator maintains or decreases the periodicity value by a predetermined value.

4. The apparatus of claim 1, wherein if the periodicity value of the first period, which is calculated with respect to the address, is greater than a predetermined reference value, the periodicity determiner determines that the address has the periodicity of the first period.

5. A method of detecting periodicity of a memory, comprising:
calculating a periodicity value of a first period with respect to an address in the memory; and
determining periodicity of the first period based on the periodicity value of the first period which is calculated with respect to the address at a point in time when a second period has elapsed.

6. The method of claim 5, wherein the calculating of the periodicity value of the first period comprises counting a number of accesses to the address corresponding to each interval of the first period during the second period, and calculating the periodicity value of the first period with respect to the address based on the calculated number of accesses.

7. The method of claim 6, wherein the calculating of the periodicity value comprises, if the number of accesses to the address corresponding to each interval of the first period is equal to or greater than 1, increasing the periodicity value by a predetermined value, and if the number of accesses to the address corresponding to each interval of the first period is 0, maintaining or decreasing the periodicity value by a predetermined value.

8. The method of claim 5, wherein the determining of the periodicity of the first period comprises:
comparing the periodicity value of the first period with a predetermined reference value; and
in response to a comparison result indicating that the periodicity value of the first period is greater than a predetermined reference value, determining that the address has periodicity of the first period.

9. An apparatus to detect periodicity of a memory, comprising:
a periodicity value calculator to count a number of times a memory address of the memory is accessed to detect a periodicity value of a first period of time with respect to the memory address; and
a periodicity determiner to determine periodicity of the first period based on the periodicity value of the first period

10. The apparatus of claim 9, wherein the periodicity value calculator counts the number of times the memory address is accessed according to a data input/output (I/O) of the memory address.

11. The apparatus of claim 9, wherein the periodicity value is calculated with respect to the address at a point in time when a second period has elapsed.

12. The apparatus of claim 9, wherein the determining of the periodicity of the first period includes comparing the periodicity value of the first period with a predetermined reference value to determine the periodicity of the first period based on the comparison result.
